(19) United States
(12) Patent Application Publication
(10) Pub. No.: US 2017/0302894 A1
(43) Pub. Date: Oct. 19, 2017

(54) COLOR LIGHT GENERATING ASSEMBLY, PROJECTION APPARATUS USING THE SAME AND PROJECTION METHOD THEREOF

(71) Applicants: Qisda Optronics (Suzhou) Co., Ltd., Suzhou (CN); Qisda Corporation, Taoyuan (TW)

(72) Inventor: CHI-CHENG LIN, Taoyuan (TW)

(21) Appl. No.: 15/381,129

(22) Filed: Dec. 16, 2016

(30) Foreign Application Priority Data
Apr. 15, 2016 (CN) 201610236131.9

(51) Int. Cl. H04N 9/31; G03B 21/16; G02B 26/00

(52) U.S. Cl. CPC H04N 9/3114; G02B 26/008; G03B 21/16

(57) ABSTRACT

A color light generating assembly includes a color wheel module and a reciprocating module. The color wheel module includes a color wheel and a first driving device. The color wheel is disposed on a transmission path of an illumination beam of the projection apparatus. An optical axis of the illumination beam irradiates the color wheel along a predetermined direction. The first driving device is configured to drive the color wheel to rotate so as to sequentially convert the illumination beam into a plurality of sub-illumination beams of different colors. The reciprocating module is connected to the color wheel module and configured to drive the color wheel module to reciprocate along a predetermined path when the color wheel is being driven to rotate by the first driving device. The predetermined direction is non-parallel to the predetermined path. A projection apparatus using the assembly and a projection method are also provided.

### FIELD OF THE INVENTION

The present invention relates to a display device, and more particularly to projection apparatus, color light generating assembly and projecting method.

### BACKGROUND OF THE INVENTION

Conventional projection apparatuses, especially digital light processing (DLP) projection apparatuses, employ color wheels to provide RGB colors for projection. Conventionally, color wheels employing fluorescent agents include a plurality of color light generating sheets. The color light generating sheets are coated with different fluorescent agents to form a plurality of phosphor layers with different colors. Therefore, lights with different colors are generated after the phosphor layers are sequentially irradiated by an illumination beam.

In response to an increasing market demand for projection apparatuses with high brightness, projection apparatuses have been developed to generate high power beams to obtain high projection brightness. Consequently, color wheels in these projection apparatuses are often overheated when irradiated by illumination beams with high power, causing adverse impacts on the fluorescent agents or adhesive agents on the color wheels; for example, affecting the optical properties or reducing the life of the color wheels.

To solve the above problems, a common approach in the prior art has been to increase the diameter of the color wheel so as to increase the heat dissipation area. However, as the rotational speed of a color wheel may reach up to 8000-9000 RPM, maintaining a dynamic balance has become an issue. Further, utilizing color wheels with large diameters may also increase the volume and manufacturing cost of the projection apparatus.

Another conventional approach for solving the above problems is to employ a fan for heat dissipation. However, rotation of the fan often generates noise or dust.

### SUMMARY OF THE INVENTION

When an illumination beam is irradiated on a conventional color wheel, the irradiated region on the color wheel in which the illumination beam is irradiated moves only in an annular region along the circumferential direction of the color wheel while the color wheel is rotating. As a result, energy of the illumination beam is concentrated and distributed within the annular region; and consequently, heat in the annular region may rise dramatically and adversely impacts on the phosphor layer of the color wheel. Therefore, one objective of the present invention is to provide a color light generating assembly capable of reducing the irradiation energy on the color wheel per unit area and consequently avoiding heat-induced deterioration of the color wheel.

Another objective of the present invention is to provide a projection apparatus equipped with the aforementioned color light generating assembly and capable of reducing the irradiation energy on the color wheel per unit area and consequently avoiding heat-induced deterioration of the color wheel.

Still another objective of the present invention is to provide a projecting method capable of reducing the irradiation energy on the color wheel per unit area and consequently avoiding heat-induced deterioration of the color wheel.

The present invention provides a color light generating assembly for a projection apparatus. The color light generating assembly includes a color wheel module and a reciprocating module. The color wheel module includes a color wheel and a first driving device. The color wheel is disposed on a transmission path of an illumination beam of the projection apparatus. An optical axis of the illumination beam irradiates the color wheel along a predetermined direction. The first driving device is engaged with the color wheel. The first driving device is configured to drive the color wheel to rotate so as to sequentially convert the illumination beam into a plurality of sub-illumination beams of different colors. The reciprocating module is connected to the color wheel module. The reciprocating module is configured to drive the color wheel module to reciprocate along a predetermined path when the color wheel is being driven to rotate by the first driving device. The predetermined direction is non-parallel to the predetermined path.

In one embodiment, the reciprocating module includes a reciprocating member, a transmission member and a second driving device. The transmission member is connected to the reciprocating member and the second driving device. The color wheel module is engaged with the reciprocating member. The second driving device is configured to drive the reciprocating member to reciprocate along the predetermined path via the transmission member.

In one embodiment, the transmission member includes a guide screw. The guide screw is screwed onto the reciprocating member. The second driving device is configured to drive the guide screw to rotate so as to enable the reciprocating member to reciprocate along the predetermined path.

In one embodiment, the transmission member includes a gear. The reciprocating member includes a gear rack meshed with the gear. The second driving device is configured to drive the gear to rotate so as to drive the gear rack to reciprocate along the predetermined path.

In one embodiment, the reciprocating module further includes at least one rail. The rail is parallel to the predetermined path and configured to guide the reciprocating member to reciprocate along the predetermined path.

In one embodiment, the predetermined path is parallel to a radial direction of the color wheel.

In one embodiment, the color wheel includes a plurality of filters of different colors.

In one embodiment, the color wheel includes a plurality of reflective sheets. Each of the reflective sheets includes a reflective layer and a phosphor layer disposed on the reflective layer. The phosphor layers of the reflective sheets exhibit different colors.

In one embodiment, a length of the predetermined path is shorter than a radius of the color wheel.

The present invention further provides a projection apparatus, which includes a light source, the aforementioned color light generating assembly, a light valve and a projection lens. The light source is configured to generate an illumination beam. The light valve is disposed on a transmission path of the plurality of sub-illumination beams generated by the color wheel of the color light generating assembly. The light valve is configured to sequentially convert the sub-illumination beams into a plurality of sub-image beams. The projection lens is disposed on a transmission path of the sub-image beams.

The present invention still further provides a projection method, which includes steps of: providing a color wheel; rotating the color wheel and reciprocating the color wheel along a predetermined path simultaneously; irradiating an illumination beam onto the rotating and reciprocating color wheel along a predetermined direction so as to sequentially convert the illumination beam into a plurality of sub-illumination beams of different colors, wherein the predetermined direction is non-parallel to the predetermined path; converting the sub-illumination beams into a plurality of sub-image beams; and projecting the sub-image beams.

In sum, according to the color light generating assembly, the projection apparatus and the projection method of the present invention, the color wheel can move in a direction different from the moving direction of the illumination beam. Therefore, the irradiated region on the color wheel in which the illumination beam L irradiates not only moves along the circumferential direction but also reciprocates along the radial direction of the color wheel. As a result, the energy of the illumination beam is uniformly distributed over a larger region on the color wheel, and the irradiation energy on the color wheel per unit area is reduced, therefore effectively avoiding heat-induced deterioration of the color wheel.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic view of a projection apparatus in accordance with an embodiment of the present invention;

FIG. 2 is a schematic view of a color light generating assembly in accordance with an embodiment of the present invention;

FIG. 3 is a schematic view of a reciprocating module in the color light generating assembly of FIG. 2 in accordance with an embodiment of the present invention;

FIG. 4 is a schematic view of a color light generating assembly in accordance with another embodiment of the present invention;

FIG. 5 is a flow chart of a projection method in accordance with an embodiment of the present invention; and

FIG. 6 is a schematic view of a color light generating assembly in accordance with still another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

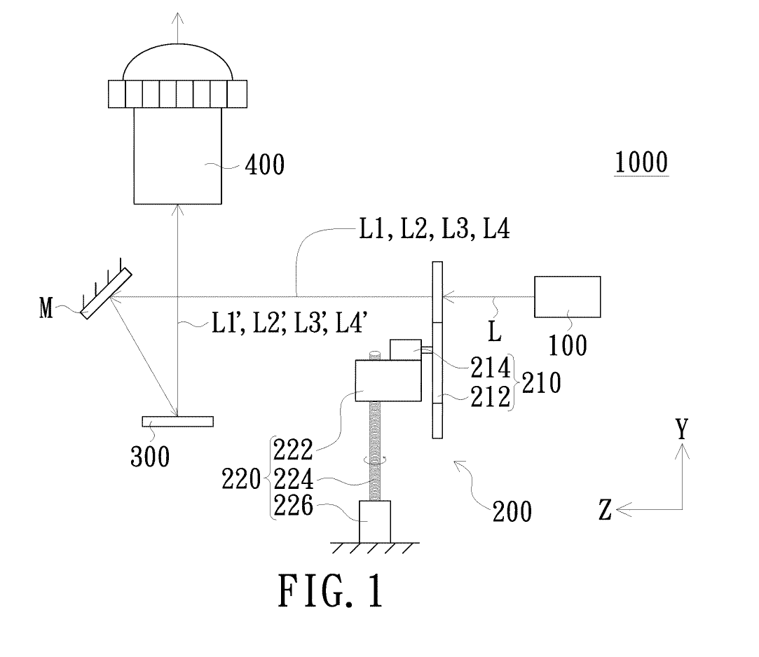

Please refer to FIG. 1, which is a schematic view of a projection apparatus in accordance with an embodiment of the present invention. As shown, the projection apparatus 1000 of the present embodiment includes a light source 100, a color light generating assembly 200, a light valve 300 and a projection lens 400. The light source 100 is configured to generate an illumination beam L. The illumination beam L is transmitted along a transmission path and irradiated onto the color light generating assembly 200. The color light generating assembly 200 is configured to sequentially convert the incident illumination beam L into a plurality of sub-illumination beams L1, L2, L3 and L4. The sub-illumination beams L1, L2, L3 and L4 exhibit different colors, such as red, green, blue and white lights respectively. The sub-illumination beams L1, L2, L3 and L4 are reflected by a mirror M of the projection apparatus 1000 and then incident onto the light valve 300 at a proper angle. The light valve 300 is configured to convert the sub-illumination beams L1, L2, L3 and L4 into a plurality of sub-image beams L1′, L2′, L3′ and L4′, respectively. The sub-image beams L1′, L2′, L3′ and L4′ are projected onto a screen (not shown) by the projection lens 400 so as to superimpose the sub-image beams L1′, L2′, L3′ and L4′ to form a color image. In the present embodiment, the light valve 300 may be a reflective digital micro-mirror device (DMD) or a liquid crystal on silicon (LCoS) panel, but the present invention is not limited thereto. In another embodiment, the light valve 300 may be a transmissive liquid crystal display (LCD) panel, working in conjunction with necessary adjustments on the related optical components and positions thereof. In another embodiment, the mirror M in FIG. 1 may be omitted or replaced by other optical components (e.g., a total internal reflection prism) with required adjustments on the related optical components and positions thereof. The structure of the color light generating assembly 200 of the present invention will be described in detail in the following.

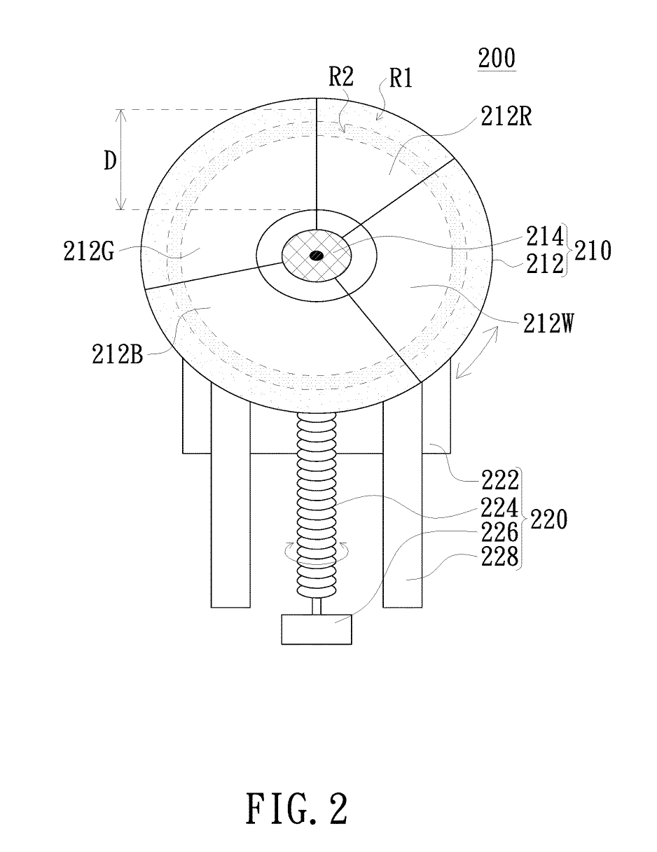

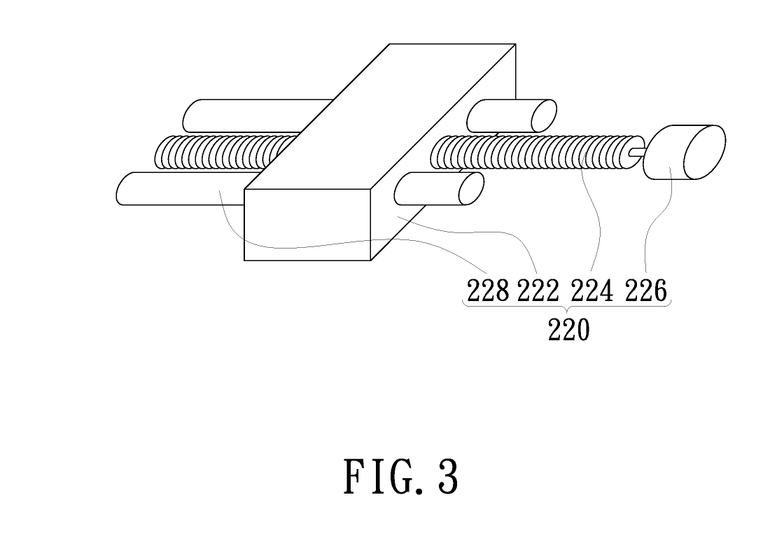

FIG. 2 is a schematic view of a color light generating assembly in accordance with an embodiment of the present invention. FIG. 3 is a schematic view of a reciprocating module of the color light generating assembly of FIG. 2 in accordance with an embodiment of the present invention. Please refer to FIGS. 2 and 3. As shown, the color light generating assembly 200 of the present embodiment includes a color wheel module 210 and a reciprocating module 220. The reciprocating module 220 is connected to the color wheel module 210 and configured to drive the color wheel module 210 to reciprocate.

The color wheel module 210 includes a color wheel 212 and a first driving device 214. The first driving device 214 is engaged with the center of the color wheel 212 and configured to drive the color wheel 212 to rotate about the center. In the present embodiment, the first driving device 214 is a motor. The rotating shaft of the motor is engaged with the center of the color wheel 212 and the motor is configured to drive the color wheel 212 to rotate about the center. The color wheel 212 may include four filters 212R, 212G, 212B and 212W. Specifically, the filter 212R is a red filter; the filter 212G is a green filter; the filter 212B is a blue filter; and the filter 212W is a white filter or a transparent sheet. Therefore, the aforementioned sub-illumination beams L1, L2, L3 and L4 of different colors are sequentially generated after the optical axis of the illumination beam L passes through the filters 212R, 212G, 212B and 212W along a predetermined direction (e.g., along a direction parallel to the Z-axis in FIG. 1), respectively.

The reciprocating module 220 includes a reciprocating member 222, a transmission member 224 and a second driving device 226. The color wheel module 210 is engaged with the reciprocating member 222. The transmission member 224 is connected to the reciprocating member 222 and the second driving device 226. In the present embodiment, the reciprocating member 222 is a reciprocating platform; the transmission member 224 is a guide screw; and the second driving device 226 is a motor. The transmission member 224 is screwed onto the reciprocating member 222 and the rotating shaft of the second driving device 226 is engaged with the transmission member 224. The second driving device 226 is configured to rotate the transmission member 224, so as to drive the reciprocating member 222 to move along a predetermined path D (i.e., to move along the transmission member 224) and consequently move the color wheel module 210 along the predetermined path D. By using the second driving device 226 to change the rotational direction of the transmission member 224, the moving direction of the reciprocating member 222 as well as the engaged color wheel module 210 would be altered; and therefore, the reciprocating module 220 of the present embodiment may enable the color wheel module 210 to reciprocate along a predetermined path. Further, in order to move the color wheel module 210 more firmly and stably, the reciprocating module 220 may further includes a rail 228, with which the reciprocating member 222 is movably engaged. Therefore, the color wheel module 210 may move with improved stability. In the present embodiment, the aforementioned predetermined path D along which the color wheel module 210 moves is, for example, parallel to the Y-axis in FIG. 1 and accordingly is perpendicular to the aforementioned predetermined direction (the direction parallel to the Z-axis in FIG. 1) along which the optical axis of the illumination beam L is irradiated onto the color wheel 212.

When the illumination beam L is irradiated onto the color wheel 212 along the aforementioned predetermined direction, the irradiated region on the color wheel 212 in which the illumination beam L irradiates moves along a circumferential direction of the color wheel 212 to form an annular region (e.g., the annular region R1), as the color wheel 212 is driven to rotate by the first driving device 214. In addition, because the color wheel 212 together with the first driving device 214 are driven by the reciprocating module 220 to move along the predetermined path D, the irradiated region on the color wheel 212 in which the illumination beam L irradiates not only moves along the circumferential direction of the color wheel 212 but also the predetermined path D parallel to the radial direction of the color wheel 212, thus expanding the irradiated region to an annular region R2 or an annular region that is even closer to the center of the color wheel 212 than the annular region R2. Therefore, the illumination beam L can be uniformly irradiated over a larger region on the color wheel 212. The length of the aforementioned predetermined path D is, for example, shorter than the radius of the color wheel 212. Although the aforementioned predetermined path D is perpendicular to the aforementioned predetermined direction in the present embodiment, the present invention is not limited thereto. That is, the illumination beam L can be uniformly irradiated over a larger region on the color wheel 212 as long as the aforementioned predetermined path D is not parallel to the aforementioned predetermined direction.

If the energy provided by the illumination beam L per unit time is W and the area on the color wheel 212 in which the illumination beam L irradiates per unit time is A, the energy received by the color wheel 212 per unit area per unit time is W/A. Namely, the larger the area A on the color wheel 212 in which the illumination beam L irradiates, the smaller the energy W/A received by the color wheel 212 per unit area per unit time Thus, in contrast to the prior art, the energy received by the color wheel 212 per unit area decrease; and consequently the problem of overheating of the color wheel 212 is solved and deterioration of the color wheel 212 is avoided.

It is to be noted that the structure of the reciprocating module of the present invention is not limited to the embodiments illustrated in FIGS. 2 and 3. Another embodiment will be exemplary provided in the following, but the present invention is not limited thereto.

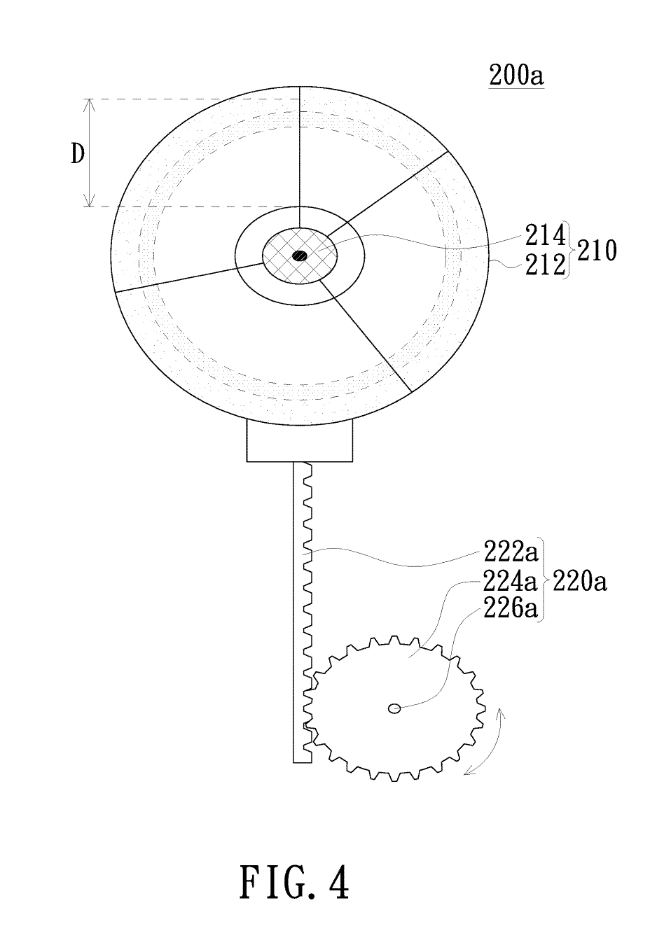

Please refer to FIG. 4, which is a schematic view of a color light generating assembly for a projection apparatus in accordance with another embodiment of the present invention. As shown, some elements in the color light generating assembly 200a in the present embodiment of FIG. 4 are identical to the corresponding elements in the color light generating assembly 200 of FIGS. 2 and 3; therefore, elements in FIG. 4 that are identical to those shown in FIGS. 2 and 3 are labeled with the same numbering for simplification and no redundant detail is to be given herein. As shown, the structure of the color light generating assembly 200a in the present embodiment of FIG. 4 is different from that of the color light generating assembly 200 of FIGS. 2 and 3. Specifically, the reciprocating module 220a of the present embodiment includes a reciprocating member 222a, a transmission member 224a and a second driving device 226a. In the present embodiment, the transmission member 224a includes at least one gear (one gear is taken as an example in FIG. 4). The reciprocating member 222a is, for example, a gear rack meshable with the aforementioned gear. The second driving device 226a is a motor (which is schematically illustrated by the rotating shaft of a motor in FIG. 4). One end of the reciprocating member 222a is attachable connected to the color wheel module 210. The second driving device 226a is configured to drive the transmission member 224a (a gear) to rotate, so as to drive the reciprocating member 222a (a gear rack) to move along a predetermined path and consequently drive the color wheel module 210 to move along the predetermined path D. By using the second driving device 226a to change the rotational direction of the transmission member 224a, the moving direction of the reciprocating member 222a as well as the engaged color wheel module 210 is altered; and therefore, the reciprocating module 220a of the present embodiment may enable the color wheel module 210 to reciprocate along the predetermined path D.

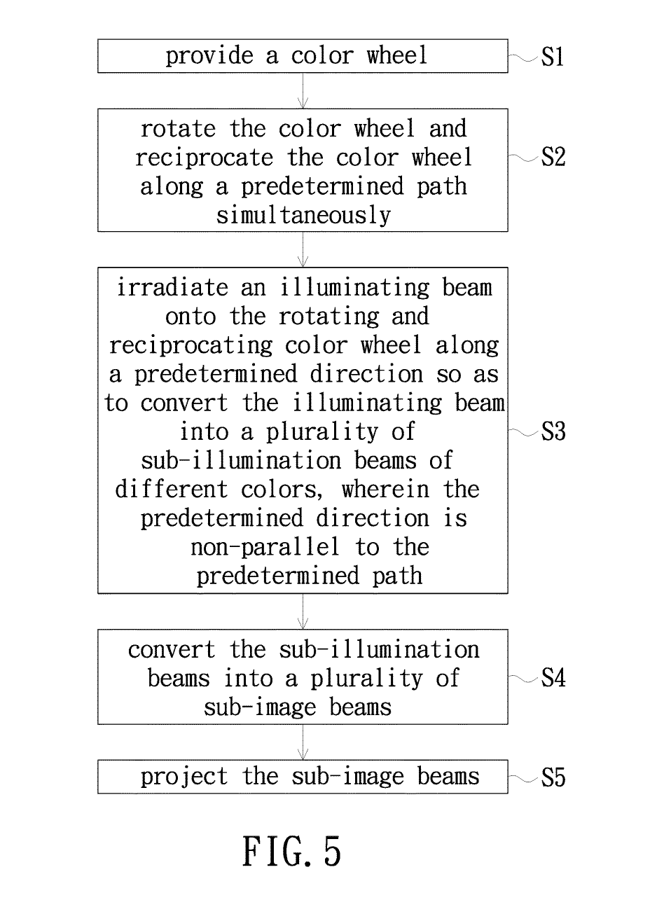

FIG. 5 is a flow chart of a projection method in accordance with an embodiment of the present invention. Please refer to FIGS. 1, 2 and 5. The projection method of the present embodiment includes the following steps. First, step S1: providing the color wheel 212. Then, step S2: rotating the color wheel 212 and reciprocating the color wheel 212 along the predetermined path D simultaneously; for example, configuring the first driving device 214 and the second driving device 226 to drive the color wheel 212 to simultaneously rotate and reciprocate, respectively.

Thereafter, step S3: irradiating the illumination beam L onto the rotating and reciprocating color wheel 212 along the predetermined direction so as to convert the illumination beam L into a plurality of sub-illumination beams of different colors (e.g., the sub-illumination beams L1, L2, L3 and L4); wherein the aforementioned predetermined direction is non-parallel to the aforementioned predetermined path D.

Thereafter, step S4: converting the sub-illumination beams into a plurality of sub-image beams; for example, configuring the light valve 300 to convert the sub-illumination beams L1, L2, L3 and L4 into the sub-image beams L1′, L2′, L3′ and L4′, respectively.

Thereafter, step S5: projecting the sub-image beams; for example, configuring the projection lens 400 to project the sub-image beams L1′, L2′, L3′ and L4′ onto a screen so as to superimpose the sub-image beams L1′, L2′, L3′ and L4′ to form a color image.

In the projection method of the present embodiment, by enabling the color wheel 212 to reciprocate along the predetermined direction D non-parallel to the moving direction of the illumination beam L, the irradiated area on the color wheel 212 in which the illumination beam L irradiates not only moves in the circumferential direction but also reciprocates in the radial direction of the color wheel 212. Therefore, the illumination beam L can be uniformly distributed over a larger region on the color wheel 212, the energy received by the color wheel 212 per unit area is reduced, and heat-induced deterioration of the color wheel 212 is avoided.

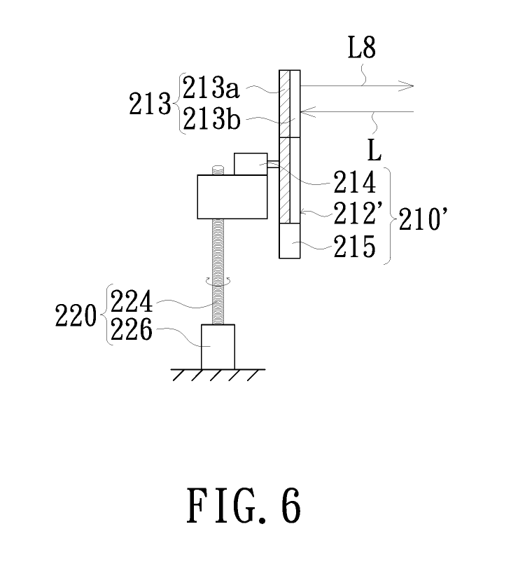

In the above embodiment, the color wheel 212 of the color wheel module 210 is a transmissive color wheel. In another embodiment, the color wheel may be a reflective color wheel. Please refer to FIG. 6, which is a schematic view of a color light generating assembly in accordance with still another embodiment of the present invention. As shown, the color wheel module 210′ of the present embodiment includes a color wheel 212′ and the first driving device 214. The first driving device 214 is engaged with the center of the color wheel 212′ and configured to drive the color wheel 212′ to rotate about the center. The color wheel 212′ includes a plurality of reflective sheets 213. Each one of the reflective sheets 213 includes a reflective layer 213a and a phosphor layer 213b formed on the reflective layer 213a. The phosphor layers 213b of the reflective sheets 213a exhibit different colors.

The phosphor layer 213b is excited to emit lights after irradiated by the illumination beam L. Specifically, the phosphor layers 213b of different colors emit lights of different colors. The lights emitted from the phosphor layers 213b are reflected by the respective reflective layers 213a to form the sub-illumination beams L8. The sub-illumination beams L8 are transmitted to a light valve (not shown) via specific optical components (such as lens, reflective element or dichroic element) and converted into a plurality of sub-image beams (not shown) by the light valve. The sub-image beams are projected onto a screen (not shown) via a projection lens (not shown). In one embodiment, the illumination beam L is a blue light; and correspondingly the phosphor layers 213b of the color wheel 212′ include a red phosphor layer and a green phosphor layer which are configured to absorb the blue light and emit a red light and a green light, respectively. In addition, the color wheel 212′ may further include a transparent sheet 215. The transparent sheet 215 and the reflective sheet 213 together form angularity. The blue light has an overlapping transmission path with the red light and green light when the blue light irradiates onto and passes through the transparent sheet 215 and is then reflected by a plurality of reflective components.

In summary, according to the color light generating assembly, the projection apparatus and the projection method of the present invention, the color wheel can move in a direction different from the moving direction of the illumination beam. Therefore, the irradiated region on the color wheel in which the illumination beam L irradiates not only moves along the circumferential direction but also reciprocates along the radial direction of the color wheel. As a result, the energy of the illumination beam is uniformly distributed over a larger region on the color wheel 212, and the irradiation energy on the color wheel per unit area is reduced, therefore effectively avoiding heat-induced deterioration of the color wheel.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A color light generating assembly for a projection apparatus, the color light generating assembly comprising:
a color wheel module, comprising:
a color wheel, disposed on a transmission path of an illumination beam of the projection apparatus, wherein an optical axis of the illumination beam irradiates the color wheel along a predetermined direction; and
a first driving device, engaged with the color wheel, wherein the first driving device is configured to drive the color wheel to rotate so as to sequentially convert the illumination beam into a plurality of sub-illumination beams of different colors; and
a reciprocating module, connected to the color wheel module, wherein the reciprocating module is configured to drive the color wheel module to reciprocate along a predetermined path when the color wheel is being driven to rotate by the first driving device, and the predetermined direction is non-parallel to the predetermined path.

2. The color light generating assembly according to claim 1, wherein the reciprocating module comprises a reciprocating member, a transmission member and a second driving device, the transmission member is connected to the reciprocating member and the second driving device, the color wheel module is engaged with the reciprocating member, and the second driving device is configured to drive the reciprocating member to reciprocate along the predetermined path via the transmission member.

3. The color light generating assembly according to claim 2, wherein the transmission member comprises a guide screw, the guide screw is screwed onto the reciprocating member, and the second driving device is configured to drive the guide screw to rotate so as to enable the reciprocating member to reciprocate along the predetermined path.

4. The color light generating assembly according to claim 2, wherein the transmission member comprises a gear, the reciprocating member comprises a gear rack meshed with the gear, and the second driving device is configured to drive the gear to rotate so as to drive the gear rack to reciprocate along the predetermined path.

5. The color light generating assembly according to claim 2, wherein the reciprocating module further comprises at least one rail, the rail is parallel to the predetermined path and configured to guide the reciprocating member to reciprocate along the predetermined path.

6. The color light generating assembly according to claim 1, wherein the predetermined path is parallel to a radial direction of the color wheel.

7. The color light generating assembly according to claim 1, wherein the color wheel comprises a plurality of filters of different colors.

8. The color light generating assembly according to claim 1, wherein the color wheel comprises a plurality of reflective sheets, each of the reflective sheets comprises a reflective layer and a phosphor layer disposed on the reflective layer, and the phosphor layers of the reflective sheets exhibit different colors.

9. The color light generating assembly according to claim 1, wherein a length of the predetermined path is shorter than a radius of the color wheel.

10. A projection apparatus, comprising:
a light source, configured to generate an illumination beam;
a color light generating assembly, comprising:
a color wheel module, comprising:
a color wheel, disposed on a transmission path of an illumination beam of the projection apparatus, wherein an optical axis of the illumination beam irradiates the color wheel along a predetermined direction; and
a first driving device, engaged with the color wheel, wherein the first driving device is configured to drive the color wheel to rotate so as to sequentially convert the illumination beam into a plurality of sub-illumination beams of different colors; and
a reciprocating module, connected to the color wheel module, wherein the reciprocating module is configured to drive the color wheel module to reciprocate along a predetermined path when the color wheel is being driven to rotate by the first driving device, and the predetermined direction is non-parallel to the predetermined path;
a light valve, disposed on a transmission path of the plurality of sub-illumination beams generated by the color wheel of the color light generating assembly, wherein the light valve is configured to sequentially convert the sub-illumination beams into a plurality of sub-image beams; and
a projection lens, disposed on a transmission path of the sub-image beams.

11. The projection apparatus according to claim 10, wherein the reciprocating module comprises a reciprocating member, a transmission member and a second driving device, the transmission member is connected to the reciprocating member and the second driving device, the color wheel module is engaged with the reciprocating member, and the second driving device is configured to drive the reciprocating member to reciprocate along the predetermined path via the transmission member.

12. The projection apparatus according to claim 11, wherein the transmission member comprises a guide screw, the guide screw is screwed onto the reciprocating member, and the second driving device is configured to drive the guide screw to rotate so as to enable the reciprocating member to reciprocate along the predetermined path.

13. The projection apparatus according to claim 11, wherein the transmission member comprises a gear, the reciprocating member comprises a gear rack meshed with the gear, and the second driving device is configured to drive the gear to rotate so as to drive the gear rack to reciprocate along the predetermined path.

14. The projection apparatus according to claim 11, wherein the reciprocating module further comprises at least one rail, the rail is parallel to the predetermined path and configured to guide the reciprocating member to reciprocate along the predetermined path.

15. The projection apparatus according to claim 10, wherein the predetermined path is parallel to a radial direction of the color wheel.

16. The projection apparatus according to claim 10, wherein the color wheel comprises a plurality of filters of different colors.

17. The projection apparatus according to claim 10, wherein the color wheel comprises a plurality of reflective sheets, each of the reflective sheets comprises a reflective layer and a phosphor layer disposed on the reflective layer, and the phosphor layers of the reflective sheets exhibit different colors.

18. The projection apparatus according to claim 10, wherein a length of the predetermined path is shorter than a radius of the color wheel.

19. A projection method, comprising:
providing a color wheel;
rotating the color wheel and reciprocating the color wheel along a predetermined path simultaneously;
irradiating an illumination beam onto the rotating and reciprocating color wheel along a predetermined direction so as to sequentially convert the illumination beam into a plurality of sub-illumination beams of different colors, wherein the predetermined direction is non-parallel to the predetermined path;
converting the sub-illumination beams into a plurality of sub-image beams; and
projecting the sub-image beams.

20. The projection method according to claim 19, wherein the predetermined path is parallel to a radial direction of the color wheel.
